(19) United States
(12) Patent Application Publication
(10) Pub. No.: US 2022/0157182 A1
(43) Pub. Date: May 19, 2022

(54) System and Method For Flight and Landing Navigation for Unpiloted Vertical and Take-Off Landing (UVTOL) Aircraft

(71) Applicant: Luuk van Dijk, Zurich (CH)

(72) Inventor: Luuk van Dijk, Zurich (CH)

(21) Appl. No.: 17/099,054

(22) Filed: Nov. 16, 2020

(51) Int. Cl. G08G 5/02; G08G 5/00

(52) U.S. Cl. CPC G08G 5/025; G08G 5/0069; G08G 5/003; G08G 5/0086

(57) ABSTRACT

The present invention provides for a decentralized and distributed functionality of a plurality of cameras to offload central processing, reduce heat dissipation, and process images for collision detection and flight path management using different categories of camera.

### BACKGROUND OF THE INVENTION

The present application pertains to aviation navigational and flight management systems and methods and, more particularly, to improved systems and methods for providing flight path and land-as-soon-as-possible and land-as-soon-as-practicable determination with navigational guidance information. Such systems and methods can be used to guide a pilot to possible and/or suitable landing sites in cases of forced and/or precautionary landings. They can also be used for real-time correction of navigational guidance based upon real-time off-course operations.

Aviation navigational systems allow a pilot to determine an aircraft's heading, altitude and position, e.g., vis-a-vis navigational beacons, the global positioning system or otherwise. Some such systems also display the host craft position relative to a pre-determined flight route and/or relative to the geography over which it is flying. These displays are typically two-dimensional (2D), though, increasingly the marketplace offers three-dimensional (3D) displays. Such aviation navigational systems allow an operator to prepare a desired flight plan between two locations. The flight plan data, which can be presented as a two-dimensional moving map or as three-dimensional views, can be visualized on an electronic display, with an associated computer providing the visualization data. As the aircraft travels along the desired flight plan path, its actual location can be indicated on the display relative to the desired flight plan. A course deviation indicator (“CDI”) can be used to indicate to an operator how far off course a vehicle is relative to a desired course, allowing the pilot to adjust the actual flight of the vehicle to attempt to match the desired flight plan. As such, current navigation systems can provide pilots with information to maintain a flight path consistent with a predetermined desired flight plan. As part of the pre-determined flight route, alternative landing sites are usually required to be determined prior to take-off.

Off-course operations are often initiated by Air Traffic Control (“ATC”) or other sources to maintain safe air traffic operations due to heavy air traffic or poor weather conditions. Such operations are typically based on specified vectors indicating heading and altitude to be maintained by the aircraft. Such headings can be provided on an absolute, relative, or magnetic basis.

Off-course operations are not accommodated by existing aviation navigation systems. Upon deviating from a desired flight plan due to a directed off-course radar vectoring, the navigation system constantly indicates the “erroneous” flight path of the vehicle, though such deviation is an intended operation. As well, existing navigation systems cannot provide guidance for the actual off-course vectoring operations. Accordingly, off-course vectoring is often performed manually, with vectoring directions written down on paper by aircraft pilots who are busily performing other piloting functions. Furthermore, upon completing off-course vectoring operations, the originally plotted flight path may not provide an efficient flight plan to the intended destination because the aerial vehicle's location is far from the desired path. Though a new flight path to the final destination may be replotted relative to the vehicle's current location, such recalculation can be disruptive to aerial vehicle operators during flight operations. As well, recalculation necessarily results in the loss of all historical data for the current flight, which can result in the loss of valuable flight information. These problems can be further compounded if multiple off-course vectoring operations occur during a particular trip.

During actual flight operations, unexpected events can occur which require off-course deviations from the pre-determined flight route or landing at unplanned sites. These events may be a result of complete loss of power to the engine(s), e.g., due to mechanical failure, fuel loss, fire and so forth. These may also arise under conditions not amounting to complete loss of engine power, including poor weather conditions, lesser equipment failures, sick passengers, and so forth. The prescribed response to such events may depend upon the type of aircraft. For complete failure on single or double engine passenger aircraft, gliding the aircraft under little or no power is required to the best (least worst) location, including but not limited to a highway or grassy area. For double engine aircraft with a single engine failure, the rules for passenger transport aircraft may require assessing whether the aircraft can reach an emergency airport within 1 hour flight distance while navigating around the airport there for up to 30 minutes before landing. Newer “extended range operations” (EROPS) certified aircraft can extend the time for single engine failure cruise to the nearest airport to 2 hours.

However, in the context of unpiloted vertical take-off and landing (UVTOL) aircraft, there may not be a prescribed response given that UVTOL landing sites and flight navigation are not limited to airports.

An object of this invention is to provide improved methods and apparatus for aerial navigation for UVTOL aircraft.

A further object of the invention is to provide such methods and apparatus as offer practical and suitable landing guidance for UVTOL aircraft and eliminate unsafe landing guidance for the UVTOL.

A still further object of the invention is to provide such methods and apparatus as can be used in cases of forced and/or precautionary landings for UVTOL aircraft.

A further object is to provide such methods and apparatus as are adapted for accommodating off-course vectoring operations for UVTOL aircraft.

A still yet further object of the invention is to provide such methods and apparatus as can be adapted for use with visualization navigation aids for UVTOL aircraft.

### SUMMARY OF THE INVENTION

The foregoing objects are among those attained by the invention which provides, in one aspect, aviation navigational and/or flight management systems and methods that accommodate unexpected course corrections and/or landing requiring real-time, built-in guidance to a nearest practical or suitable landing site.

A first system TRJ will calculate and determine a flight path plan given current global positioning (e.g., referenced in the WGS84 frame) and a number of assured waypoints. This TRJ system may be part of the central flight computer, as a separate safety critical control process, or it may be part of the system.

A second system, PLN presents this first system TRJ at any point with at least three flight and landing plans: (i) the mission-as-planned flight path plan, determined from the passengers stating their intention to go from point A to B in WGS84 coordinates (ii) a land-as-soon-as-practical plan, and (iii) a land-as-soon-as-possible plan.

The PLN system continuously takes into account the current position of the aircraft as derived from visual and other positioning systems (e.g., radar altimeter, VOR, GPS) as well as alerts from a separate collision avoidance system that provides alerts for flying or ground based obstacles (e.g., birds, planes, drones wires, towers). It also takes in the flight computers' reported possible envelope and it then updates the three plans accordingly in real time and sends updates to the TRJ.

Separate safety monitoring systems can take into account alerts from on-board safety and health monitoring systems and decide to switch the TRJ from a mission-as-planned path to either land-as-soon-as-practical or land-as-soon-possible scenarios. Dangerous narrowing of the envelope may also be a reason to switch.

One of the inputs to the PLN is the SLAM system VMU that provides visual positioning of the aircraft and potential obstacles. The aircraft's own position takes the form of position in local coordinates (which in turn are reference to global WGS84 coordinates) well as heading and altitude. The VMU may provide the low level flight computer with a separate channel of relatively high frequency position/orientation updates to aid it's low level control and stabilisation.

Related aspects of the invention provide such systems as responding to a passenger alert, e.g., pressing of a button or voice command, by providing a graphical representation of the flight path to a nearest reachable landing site.

Further related aspects of the invention provide such systems as take characteristics of the host aircraft, weather and other externalities into account in (i) identifying a nearest reachable landing site, and (ii) determining a path to that landing site. Such systems can, for example, disregard nearby landing sites that cannot be reached, e.g., under powerless flight, due to mountains (or other geographic and/or manmade features), terrain-specific approaches, and so forth. Among nearby landing sites that can be reached, such systems can, by way of further example, provide flight paths that take those geographic and manmade features, terrain-specific approaches, and so forth into account—even if those paths are non-linear—thereby insuring that the disabled aircraft can be appropriately positioned for landing.

Other aspects of the invention provide systems as described above that, additionally, accommodate real-time radar vectoring operations and/or course deviation information from a predetermined flight plan between an origin location and a desired final destination.

In related aspects, such aviation navigational and/or flight management systems can be configured to provide real-time, built-in guidance during off-course radar vectoring, and can optionally provide such guidance while maintaining actual historical flight data and associated flight plan data for reaching the desired final destination.

In further related aspects, such systems can be configured to recalculate a flight plan that provides real-time guidance to the desired final destination upon completion of radar vectoring operations, without losing historical flight data associated with the current flight. Operationally, radar vectoring can conclude with instruction to resume navigation and/or join a published approach.

Still other aspects provide such systems as can be configured to permit passengers to obtain flight data and plans as described herein using on-board systems that are portable, and/or built into an unpiloted aerial vehicle. Such systems can include a display and a processing section which are in communication. The processing section can include connections to one or more data input sources that include a position sensor (e.g., antenna in radio communication with a GPS or LO-RAN), a heading sensor (e.g., a magnetic heading source such as a compass), an altitude sensor, a source of weather data, etc.

Still further aspects provide methods that are in accord with the various operations performed by the systems described herein.

These and other aspects of the invention are evident in the drawings and in the description that follows. Advantages of methods and systems according to the invention include, among others, providing an aviation navigation system that can provide real-time guidance during off-course radar vectoring and/or during emergency landing operations. The methods and systems can also provide such radar vectoring guidance and revert back to providing guidance to a predetermined destination without losing current flight information.

### DESCRIPTION OF DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 depicts one embodiment of a processing system on which aspects of the invention may be implemented.

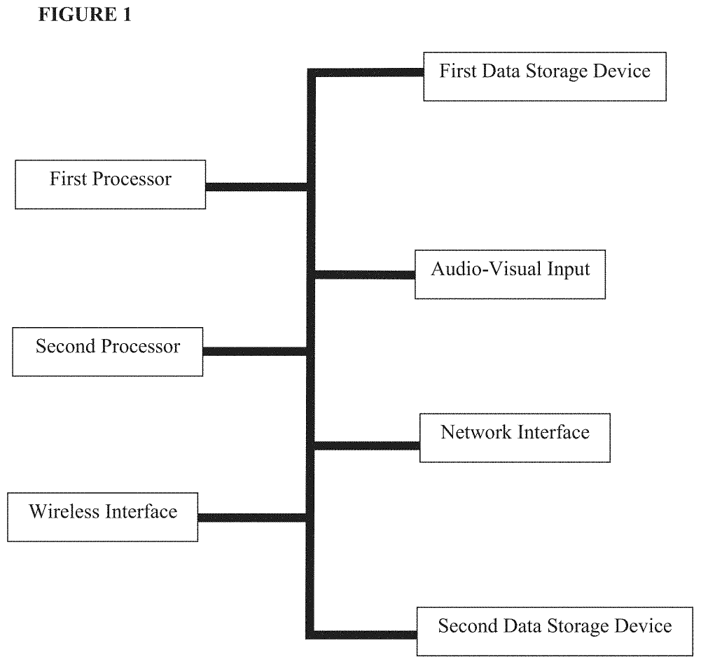

FIG. 2A represents a contour plot of digital terrain elevation data.

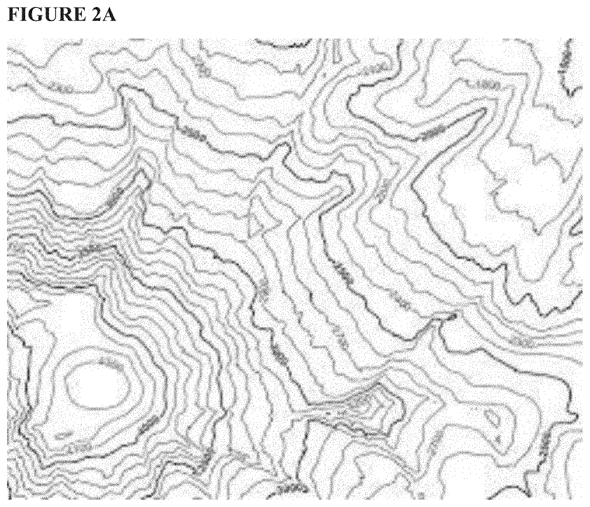

FIG. 2B is a graphical representation of terrain cover type located in the region that is depicted in FIG. 2A.

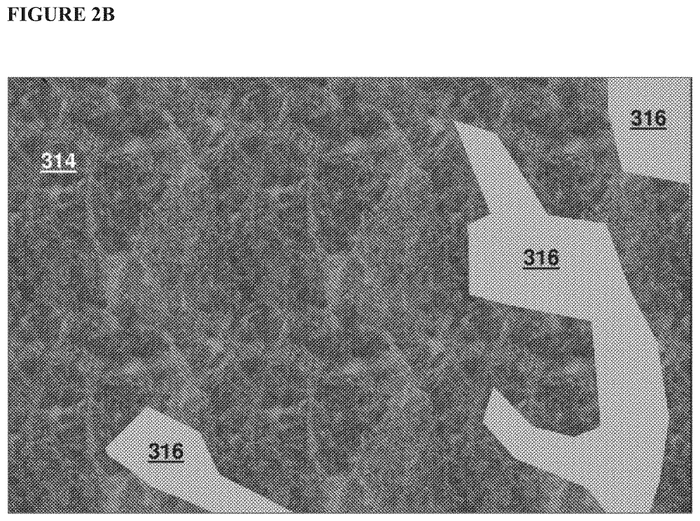

FIG. 2C is a graphical representation of surface water located in the region that is depicted in FIG. 2A.

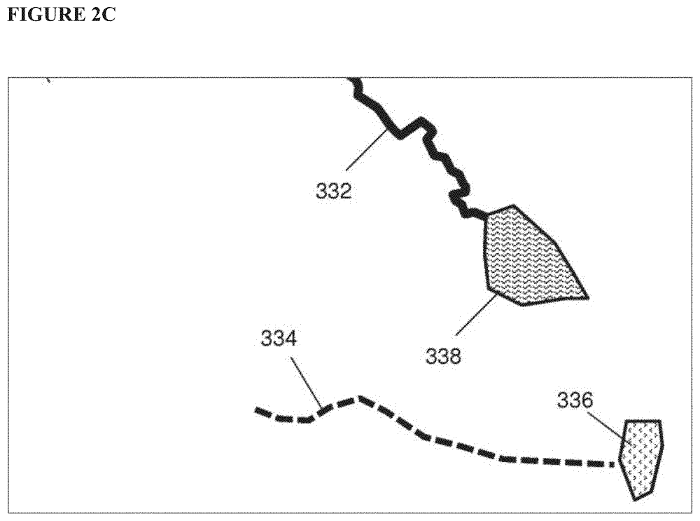

FIG. 2D is a graphical representation of flight obstacles located in the region that is depicted in FIG. 2A.

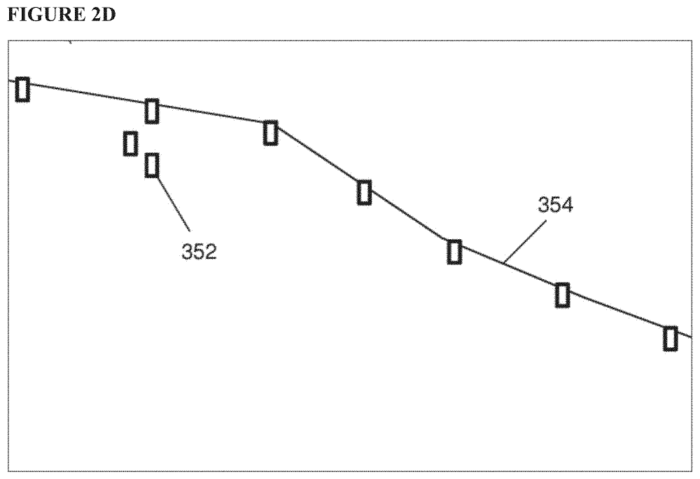

FIG. 3 represents a flow chart of a method for identifying a landing zone, according to one embodiment.

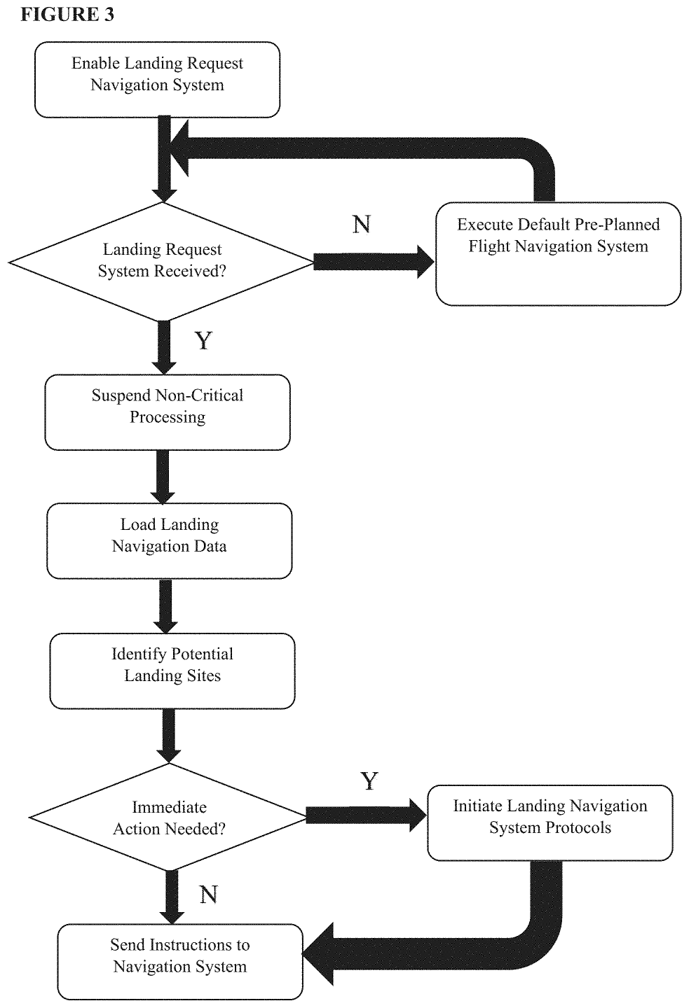

The features and advantages of the present invention will become more apparent from the detailed description set forth below when taken in

[symbol]

1. A system for determining in real-time a possible landing site for an unpiloted VTOL comprising:
at least one processor configured to receive a landing site request;
at least one audio-visual input device which creates terrain-cover information identifying ground and air cover in a region encompassing a pre-planned flight area for the aircraft;
a first data storage device storing terrain-cover, water-cover, population, and building information obtained from the audio-visual input device; and
the first or a second data storage device storing landing-zone information identifying at least one suitable non-airfield landing zone in the region, wherein
the at least one processor is configured to identify the at least one candidate landing site within a current flight-capable range of the aircraft based at least in part upon the terrain-cover information and the landing-zone information.

2. The system of claim 1, wherein upon receipt of the request the at least one processor is further configured to suspend non-critical data processing to identify the at least one candidate landing site.

3. The system of claim 1, wherein the at least one processor is part of a flight operational system for a vertical take-off and landing aircraft.

4. The system of claim 1, further comprising the first or a second data storage device storing population and building information identifying at least one location of population or buildings in the region, and wherein the at least one processor is further configured to identify the at least one candidate landing site based further upon the population and building information.

5. The system of claim 4, wherein the at least one audio-visual input device is further configured to update its terrain-cover, water-cover, population, and building information based on additional information obtained during the flight of the aircraft and the first or the second storage device storing the additional information.

6. The system of claim 4, further comprising the first or the second data storage device storing surface-water information identifying at least one location of surface-water in the region, and wherein the at least one processor is further configured to identify the at least one candidate landing site based further upon the surface-water information.

7. The system of claim 6, further comprising the first or the second data storage device storing flight-obstacle information identifying at least one location of a flight obstacle in the region, and wherein the at least one processor is further configured to identify the at least one candidate landing site based further upon the flight-obstacle information.

8. The system of claim 1, wherein the at least one processor is further configured to:
receive status information representative of aircraft flight operational systems; and
provide an interactive landing zone indicator to a pilot of the aircraft responsive to the at least one processor determining that received status information may necessitate an landing of the aircraft.

9. A method for determining in real-time a possible landing site for an unpiloted VTOL comprising receiving, by at least one processor, a landing request; and
identifying, by the at least one processor, at least one candidate non-airfield landing site within a current flight-capable range of the aircraft based at least in part upon landing-zone information and terrain-cover information descriptive of a region encompassing a pre-planned flight area of the aircraft.

10. The method of claim 9, further comprising suspending, by the at least one processor, non-critical data processing while identifying the at least one candidate non-airfield landing site.

11. The method of claim 9, wherein the at least one processor is part of a flight operational system for a vertical take-off and landing aircraft.

12. The method of claim 9, wherein the terrain-cover information is representative of at least one type of terrain cover selected from the following list: trees, dense vegetation, grass, sand, rocks, craters, uneven terrain.

13. The method of claim 9, wherein the landing-zone information identifies locations suitable for landing the aircraft that have been calculated from digital terrain elevation data.

14. The method of claim 9, wherein the landing request is issued by a pilot of the aircraft.

15. The method of claim 9, wherein the landing request is issued by the at least one processor responsive to the at least one processor determining from received status information that a landing of the aircraft may be necessary.

16. The method of claim 9, further comprising receiving, by the at least one processor, updated hostile-threat and/or allied-location information during flight of the aircraft.

17. The method of claim 16, wherein the identifying the at least one candidate non-airfield landing site is further based upon population and building information.

18. The method of claim 17, wherein the identifying the at least one candidate non-airfield landing site is further based upon flight-obstacle and/or surface-water information.

19. The method of claim 17, further comprising:
receiving, by the at least one processor, status information representative of aircraft flight operational systems;
determining from the received status information whether or not a landing of the aircraft is necessary; and
providing an interactive landing zone indicator to a pilot of the aircraft responsive to determining that a landing of the aircraft is necessary.
